(19) United States
(12) Patent Application Publication
(10) Pub. No.: US 2014/0144960 A1
(43) Pub. Date: May 29, 2014

(54) UPRIGHT BIKE MOUNT

(71) Applicant: Yakima Innovation Development Corporation, (US)

(72) Inventors: David Condon, Wilsonville, OR (US); Chris Sautter, Portland, OR (US); James Buckroyd, Portland, OR (US)

(73) Assignee: Yakima Innovation Development Corporation, Georgetown Grand Cayman (KY)

(21) Appl. No.: 13/870,891

(22) Filed: Apr. 25, 2013

Related U.S. Application Data
(60) Provisional application No. 61/640,612, filed on Apr. 30, 2012.

(51) Int. Cl. B60R 9/048; B60R 9/10

(52) U.S. Cl. CPC B60R 9/048; B60R 9/10
USPC 224/324

(57) ABSTRACT

Bike mount designs for carrying bikes in connection with vehicles are described. A bike mount may include a base and a frame or wheel-gripping arm. A bike mount frame may also have ratcheting wheel grip assemblies which may be switched between tensioning and release modes.

### CROSS-REFERENCE TO RELATED APPLICATIONS

This application is based upon and claims the benefit under 35 U.S.C. §119(e) of U.S. Provisional Patent Application Ser. No. 61/640,612, filed Apr. 30, 2012, which is incorporated herein by reference in its entirety for all purposes.

This application incorporates by reference in their entireties the following U.S. patent applications and patents: U.S. patent application Ser. No. 13/855,493 filed Apr. 2, 2013 entitled “Vehicle Rack System with a Bicycle- Gripping Carrier”; U.S. Publication No. US-2013-0062379-A1 published Mar. 14, 2013; U.S. Publication No. US-2007-0164065-A1 published Jul. 19, 2007; U.S. Publication No. US-2011-0132946-A1 published Jun. 9, 2011; U.S. Pat. No. 6,868,998 issued Mar. 22, 2005; and U.S. Pat. No 7,815,084 issued Oct. 19, 2010.

### INTRODUCTION

This disclosure relates to bike mounts for securing bikes in relation to an exterior region of a vehicle, for example, the top or the rear of a vehicle. Many different bike mount designs have been used over the years. However, there continues to be needs for bike mounts that are simple, easy to use, reliable, and cost effective to manufacture and maintain.

### SUMMARY

Bike mount configurations are disclosed for carrying bikes in an upright orientation in connection with a vehicle.

### BRIEF DESCRIPTION OF THE FIGURES

FIG. 1 is a perspective view of a first bike mount embodiment.

FIG. 2 is a perspective view of a second bike mount embodiment.

FIG. 3 is a perspective view of a third bike mount embodiment.

FIG. 4 is a perspective view of a fourth bike mount embodiment, which is similar to the third bike mount embodiment shown in FIG. 3.

FIG. 5 is a partial perspective view of a strap tightening device used on the fourth bike mount embodiment shown in FIG. 4.

FIG. 6 is another perspective view of the strap tightening device shown in FIG. 5, with a portion of the device cut away to show internal structures.

FIG. 7 is another perspective view of the strap tightening device shown in FIGS. 5 and 6, with a portion of the device cut away to show internal structures.

FIG. 8 is another perspective view of the strap tightening device shown in FIGS. 5-7.

FIG. 9 is a perspective view of internal structures contained in the strap tightening device of FIG. 5.

FIG. 10 is a perspective view of internal structures contained in the strap tightening device of FIG. 5.

FIG. 11 is a partial perspective view of the fourth bike mount embodiment, as shown in FIG. 4.

FIG. 12 is a partial perspective view of the fourth bike mount embodiment, as shown in FIG. 4.

### DETAILED DESCRIPTION

The present disclosure provides roof-mounted vehicle rack systems including a load carrier. Bicycle carriers of the present disclosure may offer substantial advantages over other rooftop carriers. In some embodiments, the load carrier may be a bicycle carrier having an elongate base and one or more arms equipped with frame-gripping or wheel-gripping devices. A frame-gripping device may be operated with an actuating member, which may be centered or located near the base. The actuating member and an arm may be mounted separately to the base. The carrier may be equipped with a frame-gripping device operable with an actuating member that is more ergonomically positioned such as positioned at a lower elevation, closer to the roof of a vehicle, spaced from the base and an arm, and which is movable independently of the arm, and/or more symmetrically positioned to permit access from either side of the vehicle. The carrier may also include a locking mechanism for a coupler that attaches the carrier to a crossbar. The locking mechanism may be adjusted with an actuating member operatively connected to a bicycle gripping device. In some embodiments, the carrier may include one or more wheel-binding devices each having a variable position along the base, to provide a more customizable fit for different bicycle configurations.

Examples of disclosed bike mounts are shown in the drawings and discussed below.

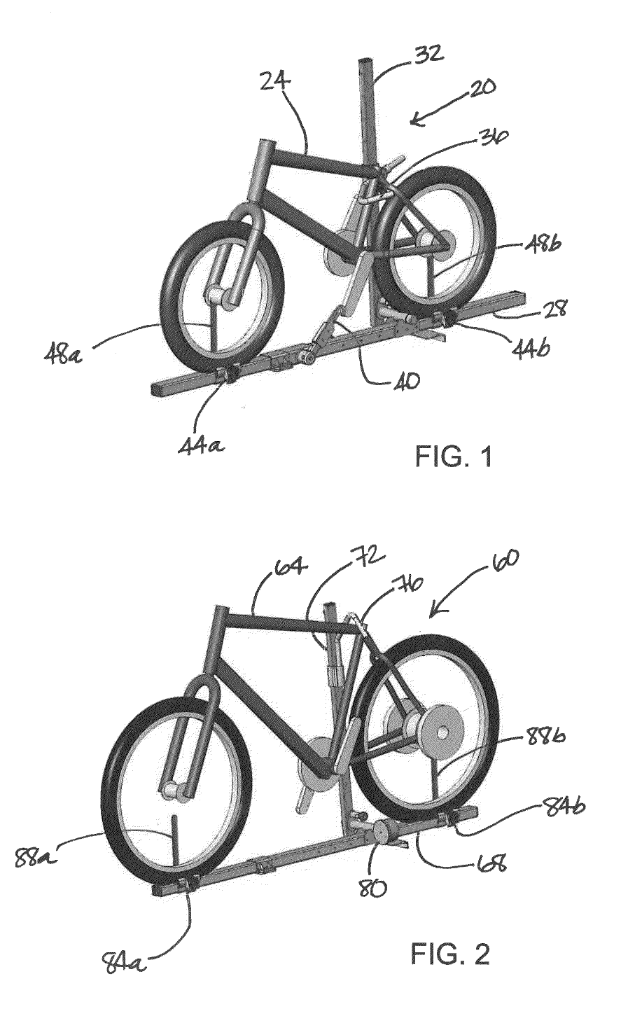

FIG. 1 shows a first bike mount embodiment 20 for securely carrying bike 24. Bike mount 20 includes base or wheel tray 28. Vertical mast or arm 32 extends upward from base 28. Mast 32 is substantially perpendicular to base 28, as shown. Adjustable hook 32 is connected to mast 32 and may be adjustable up and down to accommodate and grip a seat tube or seat post of a bike. Another adjustable hook 40 is provided along the length of base 28 for engaging a pedal of bike 24. This pulls the bike down and forward, establishing a clamping force between the pedal, spindle hook and the seat post hook. Wheel bindings 44a and 44b may be provided along the length of base 28 for gripping the wheels of bike 24 by engaging straps 48a, 48b in corresponding buckles on bindings 44a, 44b.

As shown in FIG. 1, a bike may be loaded from the side onto a tray. The vertical arm provides a backstop to keep the bike upright during loading. The bike is rolled forward so that the hook attaches to the vertical arm engaging either the seat tube or the seat post of the bike. An adjustable hook is also hooked to one pedal spindle intentioned to provide a clamping force between the pedal spindle hook and the seat post hook. It may be appreciated that the bike mount configuration shown in FIG. 1 may provide good bike support while loading. The user may select whether to have the rack contact the bike frame or the seat post. The bike mount also takes advantage of the robust structure of bike crank systems which are designed to carry high loads. The bike mount shown in FIG. 1 may also be compatible with fenders on a bike.

FIG. 2 shows a second bike mount embodiment. Bike mount 60 is configured to securely carry bike 64. Bike mount 60 includes base 68 which is preferably additionally equipped with a clamping device (not shown) for connecting base 68 to a pair of crossbars, or a frame structure configured for connection to a hitch device on the rear of a vehicle. Mast or arm 72 extends vertically from base 68, and may be adjustable along the length of base 68. Adjustable hook 76 may be selectively positioned along the length of mast 72, and is configured to grip a frame component such as the top tube of bike 64. Actuator 80 is positioned near the lower end of mast 72, and is designed to allow adjustment of the vertical height of adjustable hook 76. Wheel bindings 84a, 84b are provided for securing the wheels of bike 64, by engaging straps 88a, 88b in ratcheting buckles on bindings 84a, 84b.

In the example shown in FIG. 2, a bike is loaded from the side onto a tray. The vertical arm provides a backstop to keep the bike upright during loading. A low knob or actuator may be turned to lower or raise a hook over the bike's top tube. Wheels may be secured with straps or other binding devices. The bike mount shown in FIG. 2 does not require pre-set of the rack for specific frame sizes. It is also less sensitive to crank rotational position, in comparison to the example shown in FIG. 1. The bike mount in FIG. 2 also may be compatible with fenders.

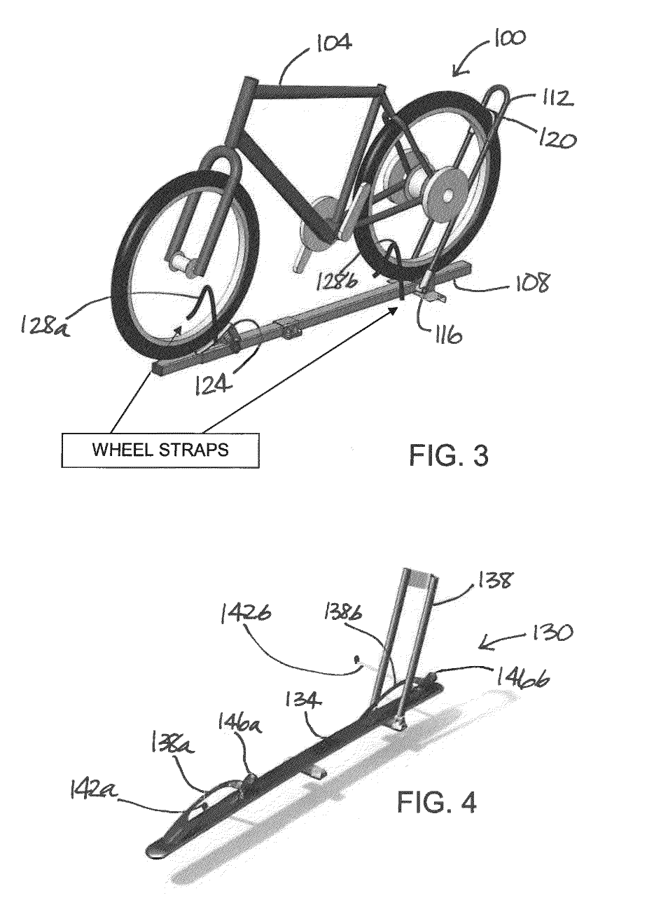

FIG. 3 shows a third bike mount embodiment 100 for securing and carrying bike 104. Bike mount 100 includes base or wheel tray 108. Base 108 may also be equipped with clamps or coupling devices for connecting base 108 to a pair of crossbars, or to a frame structure configured for connection to a hitch assembly on the rear of a vehicle. Hoop member 112 is connected to base 108 by pivot assembly 116, which allows hoop member 112 to pivot between a use position, as shown in FIG. 3, and a collapsed position in which hoop member 112 collapses onto base 108 when not in use. Adjustable gripping piece 120 may be provided on hoop member 112 for adapting the bike mount to bikes having different wheel sizes. Front wheel support member 124 may be provided for supporting a portion of the front wheel on bike 104. Wheel strap devices 128a, 128b may be provided for securing the wheels of bike 104 to base 108.

In the example shown in FIG. 3, the bike is rolled backward into an adjustable rear hoop. The wheels are pulled down and rearward by securing straps. The front wheel chok or support may include a spring-loaded or moving piece to allow pre-load of the strap and hoop system.

FIG. 4 shows a fourth bike mount embodiment which is similar in principal to the bike mount shown in FIG. 3. More specifically, bike mount 130 includes base 134 which has pivoting hoop member 138 for cradling a rear wheel of a bike. Front and back wheel cradles 138a, 138b are provided for supporting the front and rear wheels of a bike. Straps 142a, 142b are used to secure the position of a bike in the wheel cradles. Winding assemblies 146a, 146b are designed to tension and hold straps 142a and 142b around the front and rear wheels of a bike, respectively.

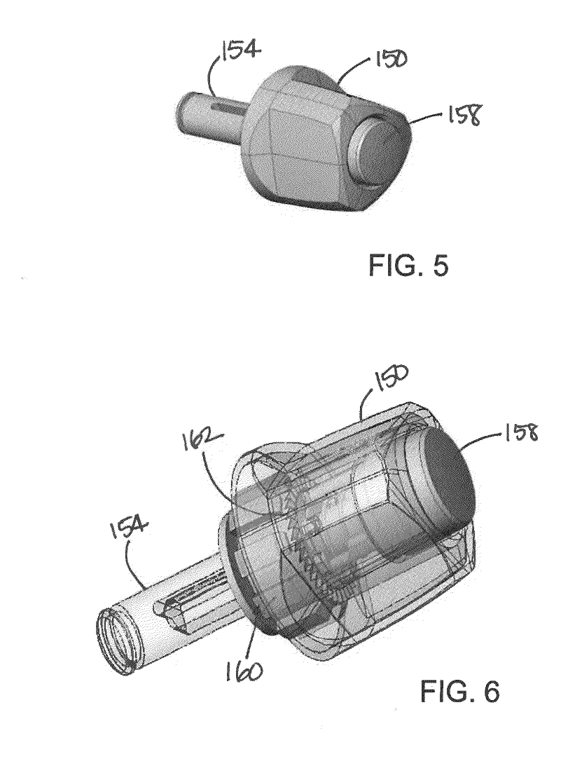

FIGS. 5-10 show components of a ratcheting device for winding, tensioning and securing one of the wheel straps on bike mount 130 of FIG. 4. More specifically, as shown in FIG. 5, handle or knob 150 includes post or spindle 154 for winding and/or wrapping, and therefore tensioning, a wheel strap. Button assembly 158 is provided in knob 150 for switching knob device 150 between a ratcheting, tensioning mode and a release mode.

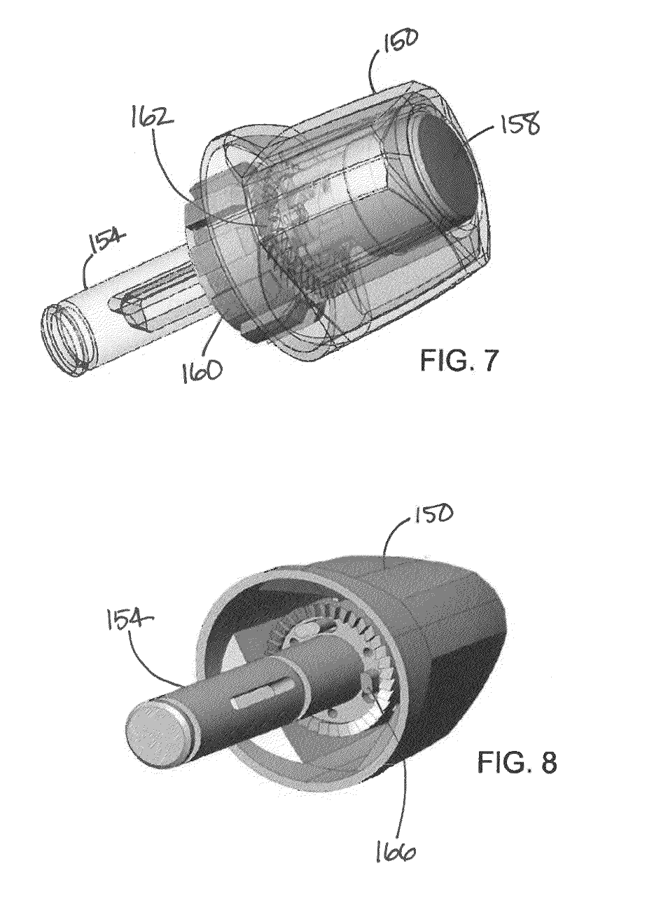

FIG. 6 shows knob device 150 in a tensioning mode, in which fixed ratchet member 160 has teeth 162 engaging corresponding teeth on knob device 150. The perspective shown in FIG. 6 illustrates how rotation of knob device 150 may only proceed in a clockwise direction, i.e., tightening direction. In contrast, FIG. 7 shows knob device 150 in a release mode in which teeth 162 on fixed ratchet member 160 are disengaged from corresponding teeth on knob device 150, thereby allowing spindle or post 154 to turn in a counter-clockwise direction, thus decreasing the tension on a wheel strap.

FIG. 8 shows prongs 166 which are connected to button 158. When button 158 is pressed downward, prongs 166 force separation between teeth 162 on fixed ratchet member 160 and the corresponding teeth on knob device 150, thereby putting knob device 150 in the release mode, as shown in FIG. 7.

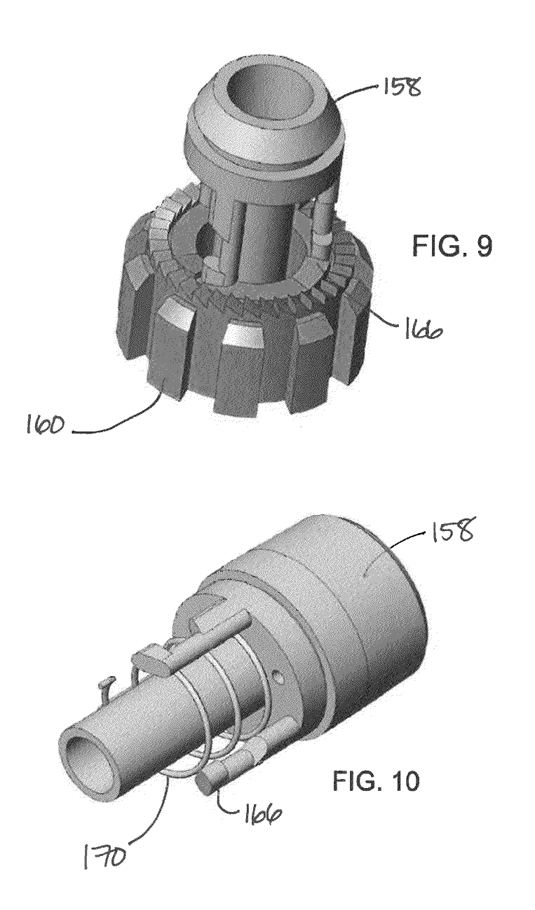

FIG. 9 shows prongs 166 of button assembly 158 engaging fixed ratchet member 160 in the release mode.

FIG. 10 shows button device 158 with prongs 166, and spring device 170 which urges button device 158 away from fixed ratchet member 160 toward the tensioning mode.

Accordingly, as shown in FIGS. 5-10, a strap winding knob includes a release button which is designed for one-hand operation and may be provided on both the front and rear of a bike mount. Straps may be wound around respective axles or spindles of each knob. The straps may be preferably made of flexible nylon webbing with a rubber coating. For example, preferred strap dimensions are about 12 mm wide and less than 1 mm thick. The straps may be as long as needed for example, about 300 mm long. A ratchet may be tied to the main body with splines, which allows the knob to hold strap tension. A space between ratchet faces is created when the release button is in the downward position. This allows the strap to be pulled out freely. When the release button is latched in the downward position, feet or prongs push against the stationary ratcheting device forcing the complementing ratchet teeth apart. Resetting the teeth on the fixed ratchet may cause the reset button to rotate and pop back to its outward position as soon as the knob is turned clockwise. Therefore, this mechanism allows simple operation in which the strap may be released by simply pushing on the button, and then transition to the tensioning mode by simply turning the knob in a clockwise direction. Springs between the reset button and the winding knob provide compression and torsion preloads. Additionally, a spring may be provided below the stationary ratcheting member to urge complementing ratchet teeth into engagement.

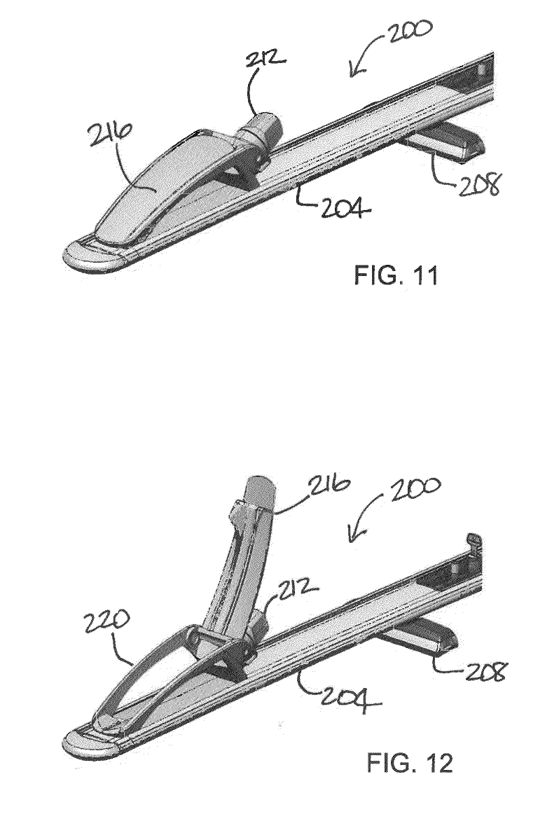

FIGS. 11 and 12 show a modification of previously-described bike mounts. Bike mount 200 includes body 204 which may be secured to one or more crossbars via docking device 208. For example, a suitable docking device described in U.S. patent application Ser. No. 13/615,344 (which is hereby incorporated by reference). Strap winding device 212 may operate substantially as previously described. Wheel chok or stop member 216 is provided for supporting the front wheel of a bike. FIG. 11 shows stop 116 in a collapsed aerodynamic position when not in use. FIG. 12 shows stop 216 rotated to a use position and side struts 220 for cradling the sides of a wheel.

While methods/devices for carrying a load on a vehicle have been particularly shown and described, many variations may be made therein. This disclosure may include one or more independent or interdependent embodiments directed to various combinations of features, functions, elements and/or properties. Other combinations and sub-combinations of features, functions, elements and/or properties may be claimed later in a related application. Such variations, whether they are directed to different combinations or directed to the same combinations, whether different, broader, narrower or equal in scope, are also regarded as included within the subject matter of the present disclosure. Accordingly, the foregoing embodiments are illustrative, and no single feature or element, or combination thereof, is essential to all possible combinations that may be claimed in this or a later application. Each example defines one or more embodiments disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second, or third, for identified elements are used to distinguish between the elements, and do not indicate a limiting number of such elements, and do not indicate a particular position or order of such elements unless otherwise specifically stated.

We claim:

1. A bike mount for mounting on top of a vehicle comprising
an elongate base having a front end and a rear end,
a hoop member pivotally mounted near the rear end of the base,
a wheel cradle connected to the front end of the base which permits a bike wheel to be rolled backwards into the cradle, and
front and rear strap tensioning assemblies, each including a dial-ratcheting actuator.

2. A bike mount for mounting on top of a vehicle comprising
an elongate base,
a mast member extending upward vertically from the base,
a first hook device adjustably mounted on the mast member for gripping a seat tube or seat post of a bike,
a second hood device mounted on the base and configured to grip a peddle spindle in tension with the first hook device, and
one or more wheel cradles positioned along the base for supporting one or more wheels of a bike.

3. A bike mount for mounting on top of a vehicle comprising
an elongate base,
a mast member extending upward vertically from the base,
a hook device adjustably mounted on the mast member for gripping a top tube of a bike,
an actuator positioned near the base operably connected to the hook device for raising and lowering the vertical position of the hook device along the mast member, and
one or more wheel cradles positioned along the base for supporting one or more wheels of a bike.
